(19) United States
(12) Patent Application Publication
(10) Pub. No.: US 2014/0161675 A1
(43) Pub. Date: Jun. 12, 2014

(54) FILTER AND METHOD FOR DEVELOPING A FILTER THAT DECREASES VOLATILE ORGANIC COMPOUNDS OF A VEHICLE

(71) Applicants: Doowon Climate Control Co., Ltd., Asan (KR); Hyundai Motor Company, Seoul (KR)

(72) Inventors: Tae Hee Lee, Hwaseong (KR); Ji Wan Kim, Yongin (KR); Sun Dong Kim, Suwon (KR); Byung Guk An, Asan (KR)

(21) Appl. No.: 13/921,575

(22) Filed: Jun. 19, 2013

(30) Foreign Application Priority Data
Dec. 12, 2012 (KR) 10-2012-0144773

(51) Int. Cl. B01D 53/04; B32B 37/16

(52) U.S. Cl. CPC B01D 53/04; B32B 37/16
USPC 422/129; 156/60

(57) ABSTRACT

Disclosed is a method for developing a filter suitable for specific volatile organic compounds (VOCs) emitted from a brand new vehicle.

### CROSS-REFERENCE TO RELATED APPLICATIONS

This application claims priority under 35 U.S.C. §119 to Korean Patent Application No. 10-2012-0144773, filed on Dec. 12, 2012, in the Korean Intellectual Property Office, the disclosure of which is incorporated herein by reference in its entirety.

### BACKGROUND

(a) Technical Field

The present invention relates to a method for developing a filter suitable for removing specific volatile organic compounds (VOCs), particularly VOCs emitted from a brand new vehicle.

(b) Background Art

Vehicles are equipped with a filter for preventing impurities from entering the vehicle from the outside. Charcoal, activated carbon, etc. are typically used as filtering materials to remove volatile organic compounds (VOCs) from the passenger compartment of a vehicle. Such filters are provide in the air-conditioning system of a vehicle not only to reduce the offensive odor from the air conditioner, but also to remove the smell emitted from a brand new vehicle. The compounds which cause the smell of a brand new vehicle can lead to nausea, vomiting, dizziness, irritation to the eyes and, in severe cases, disturbance of the human nervous or immune system. Thus, it is important to provide filters that will remove such compounds.

As existing vehicle air-conditioning systems, Korean Patent Application Publication No. 2012-063845 describes a method of sampling and analyzing vehicle indoor air pollutants including VOCs. Further, Korean Patent Application Publication No. 2011-108958 describes a filter with nanoparticles capable of removing VOCs by attachment.

However, since the existing filters for VOCs adsorb all VOCs in the passenger compartment of a vehicle indiscriminatingly, they become saturated very quickly, resulting in an inadequately short operation life. This will not be problematic if the user changes filters frequently. However, these filters are expensive and, if they are not changed timely, offensive odor in the passenger compartment of the vehicle will aggravate.

### SUMMARY

The present invention provides a method for developing a filter, particularly a filter suitable for a brand new vehicle, the method including analyzing volatile organic compounds (VOCs) emitted from interior parts of different brand new vehicles, determining the substances that cause offensive odor and substances that are harmful to the human body from the analyzed compounds, selecting specific adsorbent materials capable of capturing the determined substances and combining the selected adsorbent materials to provide a filter.

In one aspect, the present invention provides a method for developing a filter for decreasing VOCs, including:

(a) collecting an indoor gas from a brand new vehicle;

(b) analyzing the collected gas;

(c) determining target VOCs;

(d) selecting adsorbent substances for the target VOCs; and

(e) combining the adsorbent substances to provide a filter.

Other features and aspects of the present invention will be apparent from the following detailed description, drawings and claims.

### BRIEF DESCRIPTION OF THE DRAWINGS

The above and other objects, features and advantages of the present invention will now be described in detail with reference to certain exemplary embodiments thereof illustrated in the accompanying drawings which are given hereinbelow by way of illustration only, and thus are not limitative of the invention, and wherein:

FIG. 1 describes a method for developing a filter for decreasing volatile organic compounds (VOCs) for a brand new vehicle; and

FIG. 2 schematically shows filtering of offensive odor, VOCs and dust by a filter for decreasing VOCs of the present invention.

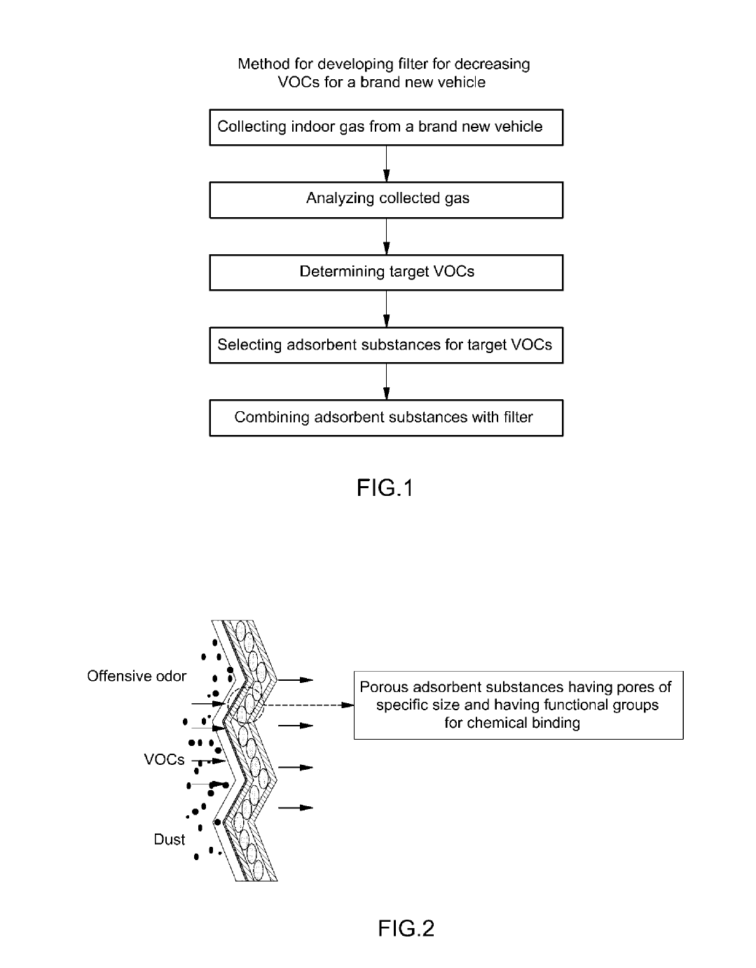

It should be understood that the appended drawings are not necessarily to scale, presenting a somewhat simplified representation of various preferred features illustrative of the basic principles of the invention. The specific design features of the invention as disclosed herein, including, for example, specific dimensions, orientations, locations and shapes, will be determined in part by the particular intended application and use environment.

### DETAILED DESCRIPTION

Hereinafter, reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Numerous volatile organic compounds (VOCs) are emitted from a brand new vehicle, including acetaldehyde, propionaldehyde, acetic acid, butanol, trimethylamine, butyric acid, hexanol, etc. The kind and concentration of the VOCs vary greatly depending on what materials are used for the interior parts of the brand new vehicle. In general, the VOCs from the brand new vehicle do not cause a severe problem since they are thoroughly controlled during the manufacture of the vehicle. However, when VOCs adsorbed to different parts of the vehicle, such as an evaporator core of an air conditioner, are emitted at once such as during use of the vehicle, they may cause offensive odor and unpleasantness. If a small amount of VOCs is filtered by a filter, the vehicle may be made more pleasant. The present invention provides a filter customized for VOCs, particularly a filter that may be used in any application related to air conditioning. The filter can also be suitable for any product that filters harmful substances, such as a gas mask.

The present invention provides a method for developing a filter for decreasing VOCs, including:

(a) collecting an indoor gas from a brand new vehicle;

(b) analyzing the collected gas;

(c) determining target VOCs;

(d) selecting adsorbent substances for the target VOCs; and

(e) combining the adsorbent substances to provide a filter.

In the step (a), a gas circulating through an air-conditioning system of a brand new vehicle is collected using a method commonly employed in the related art. More specifically, it may be performed by a-1) hermetic sealing three out of the four vehicle air conditioner exhausts, a-2) covering the remaining one exhaust through which air can flow using a glass tube and a vinyl bag, a-3) connecting the opening of the vinyl bag (e.g., a 10-L PE sample bag) to the glass tube and a-4) operating the air conditioner at level 2 under an internal ventilation condition and collecting a gas in the vinyl bag.

In the step (b), the collected gas may be analyzed using the following method and apparatus. Among VOCs, the seven compounds specified as foul odor substances, i.e. styrene, toluene, xylene, methyl ethyl ketone (MEK), methyl isobutyl ketone (MIBK), butyl acetate and isobutyl alcohol, may be detected using a Tenax-TA adsorbent tube (Supelco, U.S.A) in which 200 mg or more of a Tenax-TA absorbent is filled. After the collection, the Tenax-TA adsorbent tube may be kept at a temperature of about 4° C. and analyzed by GC/MSMS (3800GC/1200L, Varian, U.S.A). Alternatively, other GC/MS techniques known to those skilled in the art may be used for analysis.

### EXAMPLE 1

GC/MS analysis data for an indoor gas from a brand new vehicle are given in Table 1. Air conditioner air and indoor air (air from the passenger compartment) from a brand new vehicle were individually collected and analyzed. The brand new vehicle used in the test was specially manufactured for the test.

TABLE 1

| | | | Concentration [ppb] | |
|---|---|---|---|---|
| | | Detection limit | Air condi- | |
| No. | Substance | [ppb] | tioner air | Indoor air |
| 1 | Ammonia | 150 | 120.000 | n.d |
| 2 | Acetaldehyde | 1.5 | 12.668 | 7.639 |
| 3 | Propionaldehyde | 1.0 | 2.841 | 0.349 |
| 4 | Butyraldehyde | 0.67 | 3.830 | 0.411 |
| 5 | Isovaleraldehyde | 0.1 | 1.276 | 0.021 |
| 6 | Valeraldehyde | 0.41 | 1.677 | 0.076 |
| 7 | Hydrogen sulfide | 0.41 | n.d | n.d |
| 8 | Methyl mercaptan | 0.07 | n.d | n.d |
| 9 | Dimethyl sulfide | 3.0 | 0.303 | n.d |
| 10 | Dimethyl disulfide | 2.2 | n.d | n.d |
| 11 | Trimethylamine | 0.032 | 0.021 | n.d |
| 12 | Toluene | 330 | 94.403 | 61.102 |
| 13 | m,p-Xylene | 41 | 37.441 | 26.458 |
| 14 | o-Xylene | 380 | 23.486 | 16.809 |
| 15 | Styrene | 35 | n.d | n.d |
| 16 | Methyl ethyl ketone | 440 | 12.157 | 9.738 |
| 17 | Methyl isobutyl ketone | 17 | 8.967 | 6.781 |
| 18 | Propionic acid | 5.7 | n.d | n.d |
| 29 | n-Butyric acid | 0.19 | 0.041 | n.d |
| 20 | n-Valeric acid | 0.037 | n.d | n.d |
| 21 | Isovaleric acid | 0.078 | n.d | n.d |
| 22 | Isobutyl alcohol | 26,000 | 4.791 | 3.434 |

In Table 1, the detection limit is the lowest concentration that can be detected by smelling. In the step (c), target VOCs which contributed a lot to offensive odor were determined based on their measured concentration as compared to a threshold value, which is a minimum concentration that enables detection of the smell by the human nose. The threshold value varies depending on components of the smell, ranging from very low to very high.

After carrying out sensory evaluation for each substance with a large threshold value, main components were determined by comparing the results for the air conditioner air and the indoor air. Results of carrying out sensory evaluation considering threshold values and determining the VOCs contributing to the odor from the vehicle are given in Table 2.

TABLE 2

| | | | Concentration [ppb] | | |
|---|---|---|---|---|---|
| | | Detection | Air condi- | Indoor | Threshold |
| No. | Substance | limit [ppb] | tioner air | air | value |
| 1 | Acetaldehyde | 1.5 | 12.668 | 7.639 | 8.446 |
| 2 | Propionaldehyde | 1.0 | 2.841 | 0.349 | 2.841 |
| 3 | Butyraldehyde | 0.67 | 3.830 | 0.411 | 5.716 |
| 4 | Isovaleraldehyde | 0.1 | 1.276 | 0.021 | 12.758 |
| 5 | Valeraldehyde | 0.41 | 1.677 | 0.076 | 4.091 |

In Table 2, the threshold value was the detected concentration divided by the detection limit. The threshold values may be an effective means for evaluating the contribution of each substance to the smell of the vehicle. As noted above, the detection limit is the lowest concentration that can be detected by smelling. Thus, the threshold value is a very important factor that is indicative of the intensity of odor.

In the step (d), adsorbent substances for the target VOCs are selected. This can be accomplished, for example, by selecting adsorbent substances having pore sizes similar to the sizes of the determined VOCs and having functional groups capable of chemically binding with the VOCs. At present, a technique of capturing similar substances separately is available. For example, porous adsorbent substances having functional groups which are capable of capturing acetaldehydes and fatty acids may be selected. In the step (e), the a filter is prepared using the combination of selected adsorbent substances. For example, the selected porous adsorbent substances may be provided between a filter paper for filtering dust and a filter paper for attaching the adsorbent substances according to a commonly employed filter preparation method.

An exemplary embodiment of a combination filter for reducing offensive odor was prepared as follows.

The filter configuration was “spunbond nonwoven (70 g/m²)+Epoclean® (deodorant, 200 g/m²) (Taesung Environment Institute Co., Ltd., Korea)+melt-blown nonwoven (30 g/m²)+support nonwoven (15 g/m²)”.

Step 1. Lamination

A melt-blown nonwoven was laminated with a PP nonwoven (15 g/m²).

Step 2. Binder Treatment

The resulting laminate was bonded with Epoclean® (200 g/m²) and a spunbond nonwoven (70 g/m²) through binder treatment.

Step 3. Bending

The nonwoven laminate was cut to have a designed filter width and bent to have a designed number of grooves.

Step 4. Assembly

Nonwovens were bonded on the filter sample to maintain filter shape and to more completely prevent passage of dust. Although nonwovens were bonded on two sides for a general vehicle filter, nonwovens were bonded on four sides of the filter sample in this example.

Test Example

1) Adsorption of VOCs

Sensory evaluation was carried out first by seven panelists listed in Table 3 (Lee, Kim, Ahn, Kim, Kim, Son and Lim) at a concentration 100 times higher than that detected from a vehicle. After passing through the filter, the odor intensity decreased by 2 or more levels based on the panelist feedback. The same test was repeated 3 times and the results are given in Table 3.

TABLE 3

| Samples | Lee | Kim | Ahn | Kim | Kim | Son | Lim |
|---|---|---|---|---|---|---|---|
| Initial (100 times | 4.0 | 5.0 | 5.0 | 5.0 | 5.0 | 5.0 | 5.0 |
| higher) | | | | | | | |
| After passing filter | 2.5 | 3.0 | 3.0 | 2.5 | 1.5 | 2.0 | 2.5 |
| once | | | | | | | |
| After passing filter | 2.5 | 3.0 | 3.0 | 2.5 | 1.5 | 2.0 | 2.5 |
| twice | | | | | | | |
| After passing filter | 3.0 | 3.5 | 3.5 | 2.5 | 1.5 | 2.0 | 2.5 |
| thrice | | | | | | | |

Gas analysis results were as follows.

From Table 4, it was demonstrated that the target gases were removed very effectively.

TABLE 4

| | | | After | |
|---|---|---|---|---|
| | Detection | Initial | passing | Removal |
| | limit | concentration | filter | efficiency |
| Substances | [ppm] | [ppm] | [ppm] | [%] |
| Acetaldehyde | 0.001 | 1.05 | 0.03 | 97.1 |
| Propionaldehyde | 0.001 | 0.32 | n.d. | 99.7 |
| Butyraldehyde | 0.001 | 0.35 | 0.01 | 97.1 |
| Isovaleraldehyde | 0.001 | 0.12 | n.d. | 99.0 |
| Valeraldehyde | 0.001 | 0.19 | n.d. | 99.4 |
| Butyric acid | 0.001 | 0.016 | n.d. | 99.0 |

(*n.d. = not detected)

2) Operation Life

Results of testing long-term gas capturing ability were as follows.

Tests were carried out at concentrations 100 times higher than those detected from a vehicle, as described in Table 5.

TABLE 5

| Substances | Molecular weight | Density | Concentration [ppm] |
|---|---|---|---|
| Acetaldehyde | 44 | 0.788 | 1.050 |
| Propionaldehyde | 58.08 | 0.805 | 0.320 |
| Butyraldehyde | 72 | 0.8 | 0.350 |
| Isovaleraldehyde | 86.13 | 0.797 | 0.120 |
| Valeraldehyde | 86.13 | 0.81 | 0.190 |
| Butyric acid | 88.12 | 0.964 | 0.016 |

A result of injecting gases with 100 times higher concentrations and analyzing by GC/MS at different times is given in Table 6. It was demonstrated that the gas removal ability was maintained for a long period of time.

TABLE 6

| | Analysis result [ppm] | | | | | |
|---|---|---|---|---|---|---|
| Date of | Acetal- | Propional- | Butyral- | Isovaleral- | Valeral- | Butyric |
| test | dehyde | dehyde | dehyde | dehyde | dehyde | acid |
| Initial | 1.05 | 0.32 | 0.35 | 0.12 | 0.19 | 0.016 |
| 2012 Oct. | 0.06 | n.d. | 0.02 | n.d. | n.d. | n.d. |
| 08 a.m. | | | | | | |
| 2012 Oct. | 0.04 | n.d. | 0.02 | n.d. | n.d. | n.d. |
| 08 p.m. | | | | | | |
| 2012 Oct. | 0.04 | n.d. | 0.01 | n.d. | n.d. | n.d. |
| 12 a.m. | | | | | | |
| 2012 Oct. | 0.04 | n.d. | 0.02 | n.d. | n.d. | n.d. |
| 12 p.m. | | | | | | |
| 2012 Oct. | 0.03 | n.d. | 0.03 | n.d. | n.d. | n.d. |
| 15 a.m. | | | | | | |
| 2012 Oct. | 0.05 | n.d. | 0.02 | n.d. | n.d. | n.d. |
| 15 p.m. | | | | | | |
| 2012 Oct. | 0.05 | n.d. | 0.03 | n.d. | n.d. | n.d. |
| 19 a.m. | | | | | | |
| 2012 Oct. | 0.04 | n.d. | 0.03 | n.d. | n.d. | n.d. |
| 19 p.m. | | | | | | |

(*n.d. = not detected)

The present invention provides a method for capturing specific harmful VOCs causing offensive odor rather than undiscriminatingly adsorbing gases. As such, the present method is capable of providing a filter having extended operation life. The present invention also provides an air filter that is very effective for capturing specific VOCs from a brand new vehicle.

The present invention has been described in detail with reference to specific embodiments thereof. However, it will be appreciated by those skilled in the art that various changes and modifications may be made in these embodiments without departing from the principles and spirit of the invention, the scope of which is defined in the appended claims and their equivalents.

What is claimed is:

1. A method for developing a filter for decreasing volatile organic compounds (VOCs) of a brand new vehicle, comprising:
collecting an indoor gas from a brand new vehicle;
analyzing the collected gas;
determining target VOCs;
selecting adsorbent substances for the target VOCs; and
forming the filter using a combination of the selected adsorbent substances.

2. The method according to claim 1, wherein said determining target VOCs comprises determining the target VOCs based on an odor quality and detected concentration of each compound.

3. The method according to claim 1, wherein said selecting adsorbent substances for the target VOCs comprises selecting adsorbent substances having pore sizes similar to sizes of the target VOCs and having functional groups capable of chemically binding with the target VOCs.

4. The method according to claim 3, wherein said selecting adsorbent substances comprises selecting adsorbent substances having functional groups capable of capturing acetaldehydes and fatty acids.

5. The method according to claim 1, wherein said forming the filter using a combination of the selected adsorbent substances comprises attaching the selected adsorbent substances between filter papers to form the filter or attaching the selected adsorbent substances onto a filter paper to form the filter.

6. The method of claim 1, wherein the target VOCs are acetaldehyde, propionaldehyde, butyraldehyde, isovaleraldehyde, valeraldehyde, and butyric acid.

7. A filter for decreasing volatile organic compounds (VOCs) of a brand new vehicle, the filter formed by the method of claim 1.

8. The filter of claim 7, wherein the target VOCs are acetaldehyde, propionaldehyde, butyraldehyde, isovaleraldehyde, valeraldehyde, and butyric acid.
